(19) United States
(12) Patent Application Publication
(10) Pub. No.: US 2003/0088968 A1
(43) Pub. Date: May 15, 2003

(54) Helical antenna and method of making the same

(76) Inventor: Atsuhito Noda, Tokyo (JP)

Correspondence Address: MOLEX INCORPORATED, 2222 WELLINGTON COURT, LISLE, IL, 60532, US

(21) Appl. No.: 10/125,915

(22) Filed: Apr. 19, 2002

(30) Foreign Application Priority Data
Apr. 27, 2001 (JP) 131174/2001

(51) Int. Cl. H01P 11/00; H01Q 13/00; H01R 43/00; H01Q 17/00

(52) U.S. Cl. 29/601; 29/600; 29/606; 29/827

(57) ABSTRACT

A helical antenna element is made by stamping a helical antenna base shape from a sheet of metal and pressing a plurality of sub-elements within the helical antenna base shape to form a helical antenna element. The helical antenna base shape includes the plurality of sub-elements, a plurality of joining pieces and at least one carrier strip. The helical antenna element may be further made by molding an insulating resin around the helical antenna element. Moreover, prior to molding the insulating resin, a ceramic cylinder may be inserted within the helical antenna element to insure the integrity of the semi-circularly pressed sub-elements. The carrier strip(s) are then removed from the joint pieces, producing the helical antenna.

### BACKGROUND OF THE INVENTION

The present invention generally relates to helical antennas used for mobile wireless telecommunications, such as with a mobile telephone or a personal hand-held system and, more particularly to an improved helical antenna and a method of making the same. Top-helical antennas, bottom-helical antennas, stationary helical antennas and other helical antennas are equally used in mobile telecommunications.

These helical antennas have windings which include metal wires wound around a bobbin and resin covers to enclose the windings. Such helical antennas are typically formed by winding the metal wire, or wires, around a bobbin. However, defects due in performance of the antenna often occur to inherent inaccuracies in winding the wire around the bobbin. Some helical antennas that are known in the art are stamped from sheet metal, as exemplified by U.S. Pat. No. 6,147,661, issued Nov. 14, 2000. However, this process requires complex tooling in that the circular body of the antenna is stamped within a plane of one or more carrier strips that support the antenna body. In this process, the antenna may be formed with slight offsets and a good circular shape is hard to obtain, which may affect the performance of the antenna.

Therefore, there exists a need for a helical antenna and method of making the same, which overcomes these disadvantages. The present invention is directed to an antenna which overcomes the aforementioned disadvantages.

### SUMMARY OF THE INVENTION

Accordingly, it is a general object of the present invention to provide a helical antenna structure that is easily constructed and avoids the disadvantages of winding a metal wire around a bobbin.

Another object of the present invention is to provide a method of making such helical antenna structure.

A further object of the present invention is to provide a helical antenna that is stamped and formed from a metal sheet, the antenna being initially stamped with an antenna body section interconnected to one or more carrier strips, the antenna body portion lying in the same plane as the carrier strip(s), the antenna body being subsequently formed into a helical shape that lies out of plane with the carrier(s), the helical shape being joined to the carrier strip(s) by joining pieces and the joining pieces lying in plane with the carrier strip(s).

In one embodiment of the present invention, a helical antenna base shape is stamped from a sheet of metal. The helical antenna base shape includes a plurality of sub-elements configured in a substantially square wave or serpentine pattern coupled to one or more joining pieces. The sub-elements and joining pieces are disposed between one or more opposing carrier strips. The plurality of sub-elements are then formed so as to extend the sub-elements away from and out of a surface plane in which the carrier strip(s) and joining pieces are disposed. The sub-elements are thus formed into a spiral, or helical, antenna element that extends from the surface plane and does not traverse this surface plane.

In another embodiment of the invention, the spiral antenna element may further include a ceramic cylinder disposed within the hollowed space defined between the pressed plurality of sub-elements to insure the integrity of the spiral antenna element, as well as to provide a nonconductive core to the radiating portion of the antenna element. Moreover, the spiral antenna element of the helical antenna may be over-molded with an insulating resin with or without dielectric capabilities so as to completely cover the antenna element. Once the spiral antenna element is formed, the carriers are removed from the joining pieces to produce the helical antenna regardless of whether the ceramic cylinder or the insulating resin are present.

These and other objects, features and advantages of the present invention will be clearly understood through a consideration of the following detailed description.

### BRIEF DESCRIPTION OF THE DRAWINGS

In the course of this detailed description, the reference will be frequently made to the attached drawings in which:

FIG. 1 is a top view of the sheet of metal having a helical antenna base shape stamped therefrom;

FIG. 2 is a perspective view of a helical antenna having a spiral antenna element disposed between opposing carriers;

FIG. 3 is an end view of the helical antenna of FIG. 2;

FIG. 4 is a perspective view of the helical antenna further having a ceramic cylinder disposed within the spiral antenna element and the spiral antenna element molded within an insulating resin;

FIG. 5 is a perspective view of the helical antenna molded within the insulating resin; and,

FIG. 6 is a flow chart illustrating the steps for making helical antennas of the present invention.

### DETAILED DESCRIPTION OF THE PREFERRED EMBODIMENTS

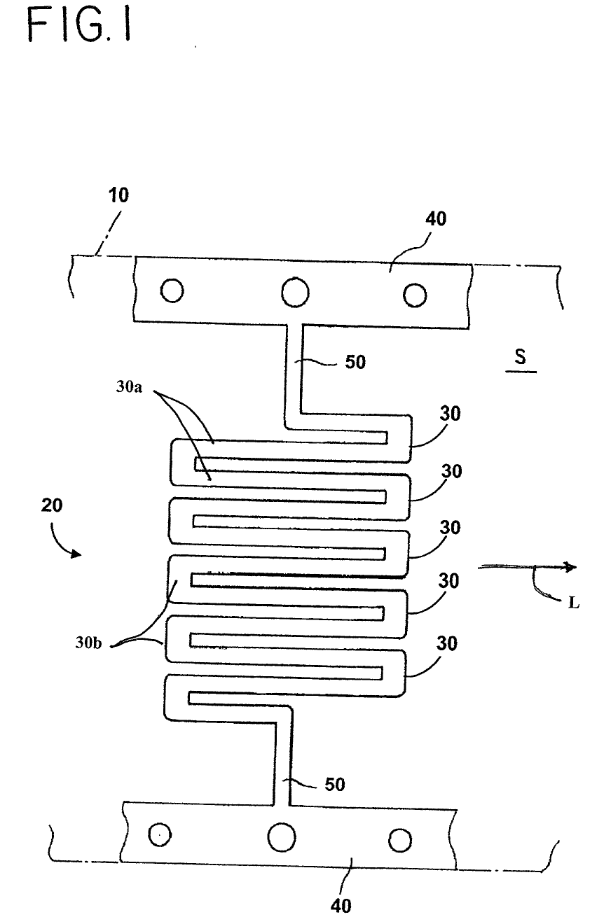

Referring to the drawings in greater detail, FIG. 1 illustrates a sheet of metal 10 in which a helical antenna base shape 20 has been stamped. The helical antenna base shape 20 includes a plurality of sub-elements 30 disposed between one or more of opposing carrier strip(s) 40, with two such carrier strips being illustrated. Preferably, the antenna base shape 20, the carrier strips 40 and the joining pieces 50 are all formed together simultaneously. The sub-elements 30 by joining pieces 50. Each sub-element 30 is composed of a portion of the thin sheet of metal disposed in a pattern that approximates a square-wave.

The plurality of sub-elements 30 extend in parallel between the opposing carrier strips 40 as illustrated and each sub-element 30 may be considered as including a pair of first metal extents, or legs, 30a that extend in a direction that is generally parallel to each other, the carrier strips 40 and a longitudinal axis L of the metal sheet. Each sub-element 30 preferably further includes one or more second metal extents, or bight portions, 30b that extend crosswise, and preferably perpendicular to the first metal extents 30a and the carrier strips 40. Each sub-element therefore may be considered as having a general U-shape. The continuous pattern demonstrated by the sub-elements 30 may also be considered as a serpentine of S-shaped pattern. The sheet of metal 10 and the helical antenna base shape 20 and the other elements 40, 50 which are stamped therefrom are disposed in a surface plane S, represented by the surface of the metal sheet 10. In the preferred embodiment, the sheet of metal is preferably composed of a resilient metal, such as oxygen-free copper or phosphor bronze.

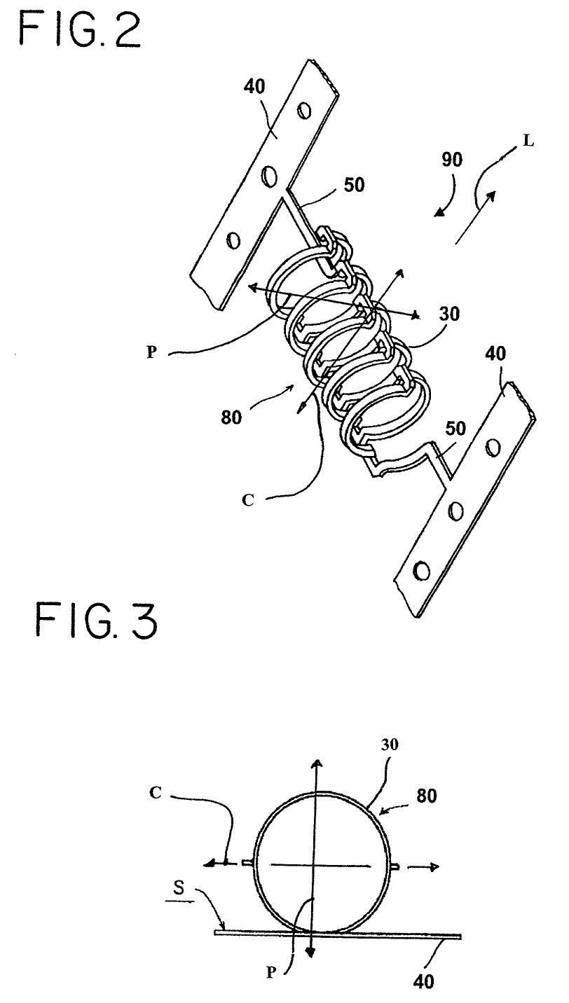

The helical antenna base shape 20 is first stamped from the sheet of metal 10. Once the helical antenna base shape 20 is removed from the sheet of metal 10, the sub-elements 30 are formed into a helical antenna element 80, as illustrated in FIG. 2. The sub-elements 30 extend away from the surface plane S as they are formed. The formed sub-elements 30 subsequently thereupon define a plurality of semi-circular sub-elements 30 which extend in vertical planes P that are perpendicular to the surface plane S in which the joining pieces 50 and carrier strips lie.

As shown best in FIGS. 2 and 3, the leg portions 30a have been formed in semi-circular fashion in opposite directions from an axis C that extends between the bight portions 30b. In this manner, the semi-circular sub-elements 30 are interconnected lengthwise and define a continuous helical, or spiral, antenna element 80 that extends between the opposing carrier strips 40. The helical antenna 90 illustrated in FIG. 2 can be formed in a top-helical, bottom helical or stationary helical configuration. As illustrated in FIG. 3, the helical antenna element 80 does not traverse the surface plane S. Rather, the helical antenna element 80 extends above the surface plane. As shown, the carrier strips 40 (only one visible) and the joining pieces (not visible) lie within the surface plane S. The helical antenna element 80 may be positioned further above the surface plane S by bending the joining pieces (not shown) slightly upward.

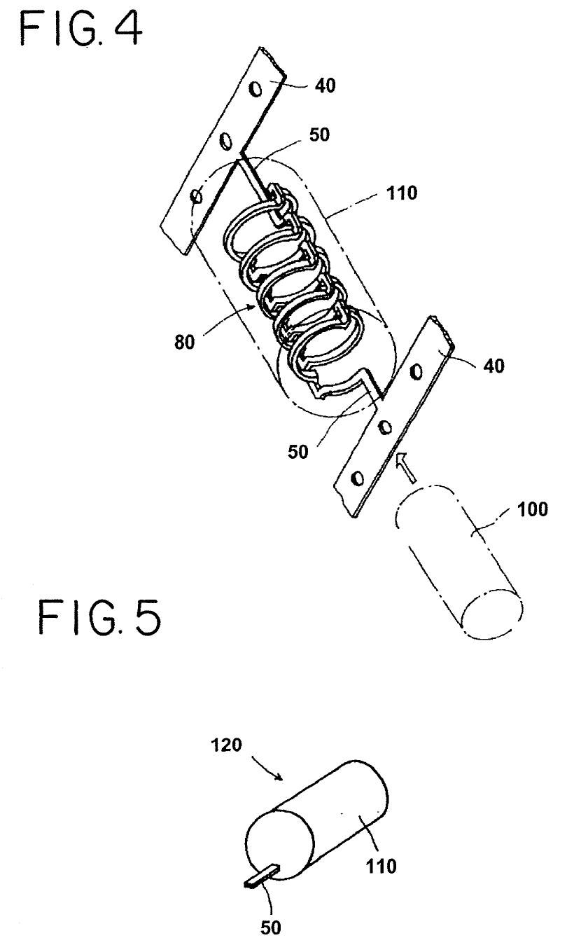

FIG. 4 illustrates another embodiment of the helical antenna of this invention. A ceramic cylinder 100 is inserted within the hollow interior space defined by the helical antenna element 80. The ceramic cylinder 100 insures the integrity of the helical antenna element 80 by engaging the semi-circular sub-elements (not specifically designated in FIG. 4). The carrier strips 40 and the joining pieces 50 remain disposed within the surface plane S as illustrated in FIG. 3, so that the ceramic cylinder 100 may be readily inserted within the interior hollow space defined by the helical antenna element 80.

FIG. 4 further illustrates another embodiment of the present invention where an outer insulator 110 is molded around helical antenna element 80 including a portion of each of the joining pieces 50. The insulator may be formed of any suitable resin, but preferably a dielectric material. In another embodiment, the ceramic cylinder 100 is disposed within the hollow space defined by the spiral antenna element 80 and the insulating resin is molded around the spiral antenna element 80, the ceramic cylinder 100 and a portion of each of the joining pieces 50 to protect the integrity of the semi-circular sub-elements 30.

FIG. 5 illustrates the completed helical antenna 120 with the insulating resin 110 molded around the helical antenna element (not visible) and portions of each of the joint pieces 50 (only one joint piece visible). Once the insulating resin 110 has been properly molded, the carrier strips (not shown) are removed from the joining pieces 50. One or more of the joining pieces 50 may extend from the molded outer housing 110 so that the antenna may be appropriately connected to a feed line, ground plane or other conductive element. Thereby, the helical antenna 120 may be properly utilized in a wireless communication device.

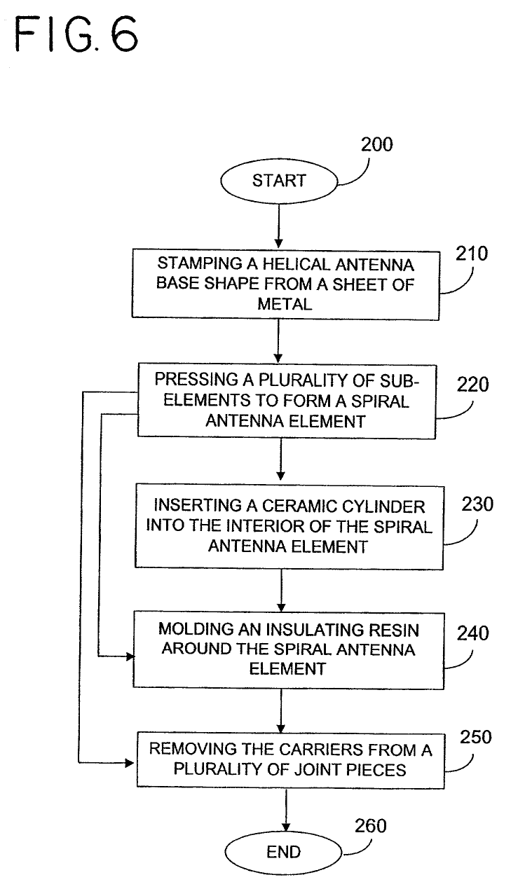

FIG. 6 is a diagram setting forth the process steps for manufacturing the helical antenna 120 of FIG. 5. The process begins at step 200 by stamping a helical antenna base shape from a sheet of metal, designated at step 210. As illustrated in FIG. 1, the helical antenna base shape 20 is stamped from the sheet of metal 10 and includes a plurality of sub-elements 30, a plurality of joining pieces 50 and a plurality of carriers 40.

Next, as illustrated in FIG. 6, the plurality of sub-elements within the helical antenna base shape are pressed to form a helical antenna element, designated at step 220. As illustrated in FIG. 2, the sub-elements 30 are pressed into a semi-circular shape to form the spiral antenna element 80.

In one embodiment of the present invention illustrated in FIG. 6, a ceramic cylinder is inserted within the interior hollow space defined by the helical antenna element, designated at step 230. As illustrated in FIG. 4, the ceramic cylinder 100 is readily inserted within the hollow space defined by helical antenna element 80 because the carriers 40 and the joining pieces 50 are disposed within the surface plane S.

In another embodiment of the present invention, as illustrated in FIG. 6, an insulating resin is molded around the helical antenna element, designated at step 240. As illustrated in FIG. 4, the insulating resin 110 encases the helical antenna element 80. As designated in FIG. 6, in one embodiment of the present invention, the ceramic cylinder is inserted within the interior hollow space defined by the helical antenna element prior to molding the insulating resin around the helical antenna element. As described above in one alternative embodiment, the insulating resin is molded around the helical antenna element without the ceramic cylinder enclosed therein.

As illustrated in FIG. 6, once the helical antenna element has been pressed, the carriers are removed, designated at step 250. The carrier strips may be removed by simply clipping the carriers from the joint pieces. In another embodiment, the carrier strips may be removed once the insulating resin is molded around the spiral antenna element. As further illustrated in FIG. 6, the carrier strips may be removed once the ceramic cylinder is inserted within the spiral antenna element and the insulating resin is molded around the helical antenna element, thus making the helical antenna such as 120 in FIG. 5, designated at step 260.

While the preferred embodiment, and further embodiments therein, have been shown and described, it will be apparent to those skilled in the art that changes and modifications may be made therein without departing from the spirit of the invention, the scope of which is defined by the appended claims.

1. A process for manufacturing a helical antenna, comprising:
providing a metal sheet;
stamping an antenna base shape in the metal sheet and simultaneously forming at least one carrier strip in said metal sheet for holding the antenna base shape during the manufacturing process; and,
forming a plurality of circular sub-elements in a helical pattern from said antenna base shape to form a helical antenna element, the helical antenna element having a hollow interior portion and said helical antenna element being disposed out of a plane in which said carrier strip lies.

2. The manufacturing process of claim 1, wherein two carrier strips are stamped in said metal sheet, spaced apart from each other a preselected distances and said antenna base shape is disposed between said two carrier strips and said antenna base shape includes a plurality of sub-elements, and a pair of joining pieces extending from opposite ends of said antenna base shape and attaching said antenna base shape to said carrier strips, said joining pieces and said carrier strips lying in a single plane.

3. The manufacturing process of claim 2, further including the step of molding an insulator around said helical antenna element.

4. The manufacturing process of claim 3 wherein the insulator is a dielectric material.

5. The manufacturing process of claim 3, further including the step of removing said antenna base shape from said carrier strips.

6. The manufacturing process of claim 3, further including the step of inserting a ceramic cylinder within said helical antenna element prior to molding the insulator around said helical antenna element.

7. A helical antenna made by the process comprising:
providing an elongated sheet of metal, the metal sheet having a longitudinal axis, and a pair of opposed marginal edges spaced apart from each other and lying on opposite sides of the longitudinal axis, the sheet marginal edges extending lengthwise of said metal sheet,
stamping a serpentine pattern and two carrier strips in said metal sheet, to thereby define an antenna element disposed between carrier strips formed along said sheet marginal edges, the antenna element and the carrier strips lying in a single plane, said antenna element further extending across said longitudinal axis and including a plurality of interconnected U-shaped portions;
forming said antenna element into a helical antenna element having a plurality of turns that extend in a continuous fashion between joining pieces that join said antenna element to said carrier strips, the helical antenna element being disposed out of the plane of said joining pieces and said carrier strips; and,
molding an insulator around the helical antenna element.

8. The helical antenna of claim 7, wherein the insulator is molded from a dielectric material.

9. The helical antenna made by the process of claim 7, further including the step of removing said helical antenna element from said carrier strips by severing said joining pieces from said carrier strips so that said joining pieces extend out of said insulator at opposite ends of said helical antenna element.

10. The helical antenna made in the process of claim 7, wherein the process further comprises: inserting a ceramic cylinder within the spiral antenna element prior to molding an insulator around the spiral antenna element.

11. A helical antenna comprising:
first and second joining pieces, and a plurality of U-shaped sub-elements disposed between the first and second joining pieces, the sub-elements having pairs of legs spaced apart from and interconnected to each other by intervening bight portions, said sub-element legs being circularly formed in opposite directions within each pair of sub-element legs to form a continuous, helical antenna element.

12. The helical antenna of claim 11, further including an insulator molded around the helical antenna element.

13. The helical antenna of claim 12, wherein the insulator is a resin.

14. The helical antenna of claim 11, further including a ceramic cylinder disposed within the helical antenna element.

15. The helical antenna of claim 14, further comprising an insulator molded around said helical antenna element.

16. The helical antenna of claim 15, wherein the insulator is a dielectric material.

17. The helical antenna of claim 11, wherein the sub-elements are composed of a resilient metal.

18. The helical antenna of claim 18, wherein the resilient metal is an oxygen-free copper.

19. The helical antenna of claim 18, wherein said resilient metal is a phosphor bronze.
